(19) United States
(12) Patent Application Publication
(10) Pub. No.: US 2023/0132156 A1
(43) Pub. Date: Apr. 27, 2023

(54) CALIBRATION OF A CAMERA ACCORDING TO A CHARACTERISTIC OF A PHYSICAL ENVIRONMENT

(71) Applicant: QUALCOMM Incorporated, San Diego, CA (US)

(72) Inventors: Pankaj CHANCHLANI, Ajmer (IN); Suresh AGARWAL, Bangalore (IN); Aswin SRINIVASARAGHAVAN, Bangalore (IN); Giridhar Dhati MANDYAM, San Diego, CA (US)

(21) Appl. No.: 17/452,292

(22) Filed: Oct. 26, 2021

(51) Int. Cl. G06T 7/80; H04N 5/235; G09G 5/10; G06K 9/00

(52) U.S. Cl. CPC G06T 7/80; H04N 5/2354; G09G 5/10; G06K 9/00604; G09G 2360/144; G09G 2354/00

(57) ABSTRACT

In some aspects, a user device may receive, from a camera of the user device, an image of a physical environment of the camera. The user device may determine, using a brightness analysis model, a first brightness associated with a first portion of the image that depicts an object. The user device may determine, using the brightness analysis model, a second brightness associated with a second portion of the image that is separate from the first portion. The user device may set, based at least in part on the first brightness and the second brightness, a brightness level of a display of the user device. Numerous other aspects are described.

### FIELD OF THE DISCLOSURE

Aspects of the present disclosure generally relate to processing an image of a camera and, for example, to proactive calibration of processing an image of a camera according to a characteristic of a physical environment of the camera.

### BACKGROUND

A user device may include a sensor (e.g., a light senor) to identify and/or measure ambient lighting within a physical environment of the user device. The user device, based on information or data from the sensor, may adjust a setting of a display of the user device to account for the ambient lighting in the physical environment.

### SUMMARY

Some aspects described herein relate to a method performed by a user device. The method may include receiving, from a camera of the user device, an image of a physical environment of the camera. The method may include determining, using a brightness analysis model, a first brightness associated with a first portion of the image that depicts an object. The method may include determining, using the brightness analysis model, a second brightness associated with a second portion of the image that is separate from the first portion. The method may include setting, based at least in part on the first brightness and the second brightness, a brightness level of a display of the user device.

Some aspects described herein relate to a user device. The user device may include one or more memories and one or more processors coupled to the one or more memories. The user device may be configured to receive, from a camera of the user device, an image of a physical environment of the camera. The user device may be configured to determine, using a brightness analysis model, a first brightness associated with a first portion of the image that depicts an object. The user device may be configured to determine, using the brightness analysis model, a second brightness associated with a second portion of the image that is separate from the first portion. The user device may be configured to set, based at least in part on the first brightness and the second brightness, a brightness level of a display of the user device.

Some aspects described herein relate to a non-transitory computer-readable medium that stores a set of instructions for a user device. The set of instructions, when executed by one or more processors of the user device, may cause the user device to receive, from a camera of the user device, an image of a physical environment of the camera. The set of instructions, when executed by one or more processors of the user device, may cause the user device to determine, using a brightness analysis model, a first brightness associated with a first portion of the image that depicts an object. The set of instructions, when executed by one or more processors of the user device, may cause the user device to determine, using the brightness analysis model, a second brightness associated with a second portion of the image that is separate from the first portion. The set of instructions, when executed by one or more processors of the user device, may cause the user device to set, based at least in part on the first brightness and the second brightness, a brightness level of a display of the user device.

Some aspects described herein relate to an apparatus. The apparatus may include means for receiving, from a camera of a user device, an image of a physical environment of the camera. The apparatus may include means for determining, using a brightness analysis model, a first brightness associated with a first portion of the image that depicts an object. The apparatus may include means for determining, using the brightness analysis model, a second brightness associated with a second portion of the image that is separate from the first portion. The apparatus may include means for setting, based at least in part on the first brightness and the second brightness, a brightness level of a display of the user device.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example environment in which a user device described herein may be implemented, in accordance with the present disclosure.

FIG. 2 is a diagram illustrating example components of one or more devices shown in FIG. 1, such as a user device, in accordance with the present disclosure.

FIG. 3 is a diagram illustrating an example associated with using an image captured by a camera of a user device to determine and/or set a brightness level of a display of the user device, in accordance with the present disclosure.

FIG. 4 is a diagram illustrating an example associated with an analysis of an image for determining and setting a brightness level of a display of a user device, in accordance with the present disclosure.

FIG. 5 is a flowchart of an example process associated with using an image captured by a camera of a user device to determine and/or set a brightness level of a display of the user device, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

A setting of a display of a user device may be adjustable and/or set according to a physical environment of the user device. For example, a brightness level of the display may be set according to a brightness of ambient lighting in the physical environment to facilitate or enhance visibility of the display for a user of the user device. In such a case, the user device may include a light sensor that is configured to measure the ambient light within the physical environment of the user device. Such a light sensor may be included within the user device to indicate the ambient light within the physical environment specifically to control a setting of the display of the user device. Accordingly, in such a case, the light sensor may not have any other purpose or use with the user device, and therefore imposes certain design constraints on the user device that can impact placement or configurations of one or more other components of the user device, such as the display and/or a camera of the user device among other examples.

Some aspects described herein provide a user device that is configured to control a setting of a display of the user device based on one or more images that are captured by a camera of the user device. For example, as described herein, the user device may analyze an image to determine a brightness of a portion of the image and set a brightness level of the display according to the determined brightness. In some aspects, the user device may determine the setting (e.g., a brightness level or other setting) for the display based on brightnesses associated with objects depicted in the image (e.g., objects determined to be different distances from the user device). In such a case, the user device may determine a first brightness of a first portion of the image (e.g., a portion that depicts a first object) with a second brightness of a second portion of the image (e.g., a portion that depicts a second object and/or a background of the image) and set the setting of the display according to the first brightness and the second brightness (e.g., based on a comparison and/or difference between the first brightness and the second brightness). As described herein, the user device may receive the image (and/or multiple images) based on one or more user interactions with the user device. For example, the user device may receive the image in association with a user moving the user device and/or causing the user device to use facial recognition to authenticate the user (e.g., to unlock the user device). Additionally, or alternatively, the user device may receive the image based on the user using or activating the camera (e.g., in association with a camera application of the user device).

Accordingly, as described herein, the user device may determine a setting for a brightness level of a display of the user device without the use of (or need for) a light sensor, thereby conserving hardware resources associated with the light sensor (e.g., by eliminating the need for the light sensor in the user device to determine the brightness level for the display) and/or removing a design constraint involved within configuring the user device to include the light sensor. Furthermore, one or more aspects described conserve computing resources (e.g., processor resources and/or memory resources) that would otherwise be consumed by specifically obtaining information that in order to determine an amount of ambient light in a physical environment. For example, computing resources may be conserved in association with causing a light sensor within a user device (e.g., because the light sensor may not be included within the user device or used to identify an amount of ambient light) to obtain and/or provide a measurement associated with the ambient light and/or computing resources that would otherwise be consumed by the user device processing information associated with the light sensor.

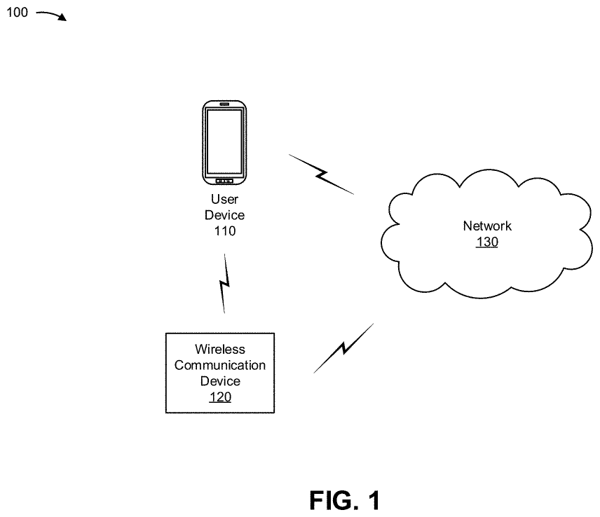

FIG. 1 is a diagram illustrating an example system 100 in which an image capture module described herein may be implemented, in accordance with the present disclosure. As shown in FIG. 1, system 100 may include a user device 110, a wireless communication device 120, and/or a network 130. Devices of the system 100 may interconnect via wired connections, wireless connections, or a combination of wired and wireless connections.

The user device 110 includes one or more devices capable of including one or more image capture modules described herein. For example, the user device 110 may include one or more devices capable of receiving, generating, storing, processing, and/or providing information associated with one or more sensors described herein. More specifically, the user device 110 may include a communication and/or computing device, such as a user equipment (e.g., a smartphone, a radiotelephone, and/or the like), a laptop computer, a tablet computer, a handheld computer, a desktop computer, a gaming device, a wearable communication device (e.g., a smart wristwatch, a pair of smart eyeglasses, and/or the like), or a similar type of device. As described herein, the user device 110 (and/or an image capture module of the user device 110) may be used to detect, analyze, and/or perform one or more operations associated with an optical character.

The wireless communication device 120 includes one or more devices capable of receiving, generating, storing, processing, and/or providing information associated with the user device 110. For example, the wireless communication device 120 may include a base station, an access point, and/or the like. Additionally, or alternatively, similar to the user device 110, the wireless communication device 120 may include a communication and/or computing device, such as a mobile phone (e.g., a smart phone, a radiotelephone, and/or the like), a laptop computer, a tablet computer, a handheld computer, a desktop computer, a gaming device, a wearable communication device (e.g., a smart wristwatch, a pair of smart eyeglasses, and/or the like), or a similar type of device.

The network 130 includes one or more wired and/or wireless networks. For example, the network 130 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks. In some aspects, the network 130 may include a data network and/or be communicatively with a data platform (e.g., a web-platform, a cloud-based platform, a non-cloud-based platform, and/or the like) that is capable of receiving, generating, processing, and/or providing information associated with an optical character detected and/or analyzed by the user device 110.

The number and arrangement of devices and networks shown in FIG. 1 are provided as one or more examples. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the system 100 may perform one or more functions described as being performed by another set of devices of the system 100.

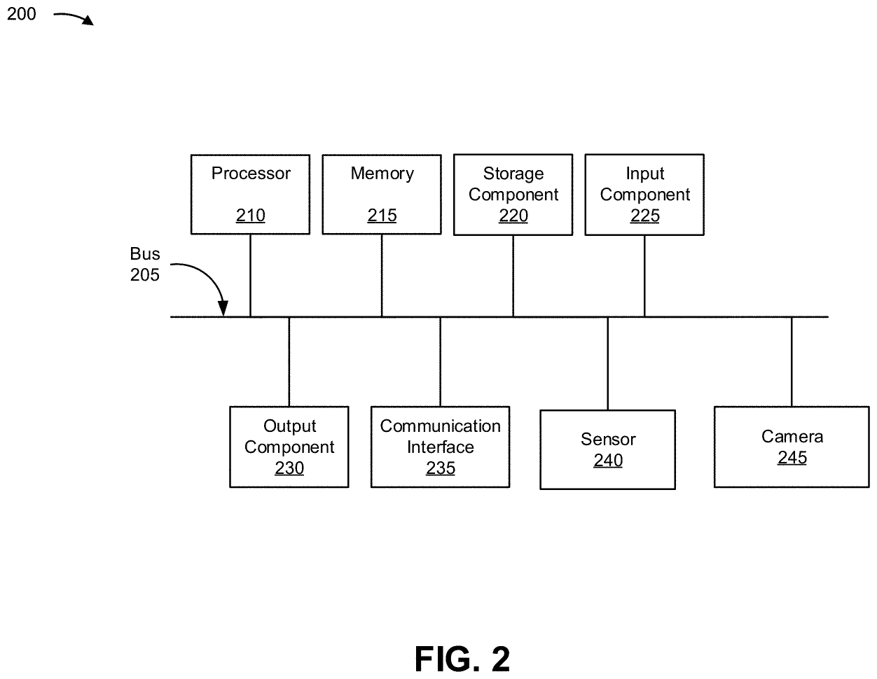

FIG. 2 is a diagram of example components of a device 200, in accordance with the present disclosure. The device 200 may correspond to the user device 110 and/or the wireless communication device 120. Additionally, or alternatively, user device 110, and/or wireless communication device 120 may include one or more devices 200 and/or one or more components of device 200. As shown in FIG. 2, device 200 may include a bus 205, a processor 210, a memory 215, a storage component 220, an input component 225, an output component 230, a communication interface 235, a sensor 240, and a camera 245.

The bus 205 includes a component that permits communication among the components of device 200. The processor 210 includes a central processing unit (CPU), a graphics processing unit (GPU), an accelerated processing unit (APU), a digital signal processor (DSP), a microprocessor, a microcontroller, a field-programmable gate array (FPGA), an application-specific integrated circuit (ASIC), and/or another type of processing component. The processor 210 is implemented in hardware, firmware, or a combination of hardware and software. In some aspects, the processor 210 includes one or more processors capable of being programmed to perform a function.

The memory 215 includes a random-access memory (RAM), a read only memory (ROM), and/or another type of dynamic or static storage device (e.g., a flash memory, a magnetic memory, and/or an optical memory) that stores information and/or instructions for use by the processor 210.

The storage component 220 stores information and/or software related to the operation and use of device 200. For example, the storage component 220 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

The input component 225 includes a component that permits the device 200 to receive information, such as via user input. For example, input component 225 may be associated with a user interface as described herein (e.g., to permit a user to interact with the one or more features of the device 200). The input component 225 may include a touchscreen display, a keyboard, a keypad, a mouse, a button, a switch, a microphone, and/or the like. The output component 230 includes a component that provides output from the device 200 (e.g., a display, a speaker, one or more light-emitting diodes (LEDs), and/or the like).

The communication interface 235 includes a transceiver and/or a separate receiver and transmitter that enables the device 200 to communicate with other devices, such as via a wired connection, a wireless connection, or a combination of wired and wireless connections. The communication interface 235 may permit the device 200 to receive information from another device and/or provide information to another device. For example, the communication interface 235 may include an Ethernet interface, an optical interface, a coaxial interface, an infrared interface, a radio frequency (RF) interface, a universal serial bus (USB) interface, a Wi-Fi interface, a cellular network interface, a wireless modem, an inter-integrated circuit (I2C), a serial peripheral interface (SPI), or the like.

The sensor 240 may include a sensor for sensing information associated with the device 200. More specifically, the sensor 240 may include a magnetometer (e.g., a Hall effect sensor, an anisotropic magnetoresistive (AMR) sensor, a giant magneto-resistive sensor (GMR), and/or the like), a location sensor (e.g., a global positioning system (GPS) receiver, a local positioning system (LPS) device (e.g., that uses triangulation, multi-lateration, and/or the like), and/or the like), a gyroscope (e.g., a micro-electro-mechanical systems (MEMS) gyroscope or a similar type of device), an accelerometer, a speed sensor, a motion sensor, an infrared sensor, a temperature sensor, a pressure sensor, and/or the like.

Camera 245 includes one or more devices capable of sensing characteristics associated with an environment of the device 200. The camera 245 may include one or more integrated circuits (e.g., on a packaged silicon die) and/or one or more passive components of one or more flex circuits to enable communication with one or more components of the device 200. In some aspects, the camera 245 may include a low-resolution camera (e.g., a video graphics array (VGA)) that is capable of capturing low-resolution images (e.g., images that are less than one megapixel and/or the like) and/or high-resolution images (e.g., images that are greater than one megapixel). The camera 245 may be a low-power device (e.g., a device that consumes less than 10 milliwatts (mW) of power) that has always-on capability while the device 200 is powered on.

The device 200 may perform one or more processes described herein. The device 200 may perform these processes in response to the processor 210 executing software instructions stored by a non-transitory computer-readable medium, such as the memory 215 and/or the storage component 220. “Computer-readable medium” as used herein refers to a non-transitory memory device. A memory device includes memory space within a single physical storage device or memory space spread across multiple physical storage devices.

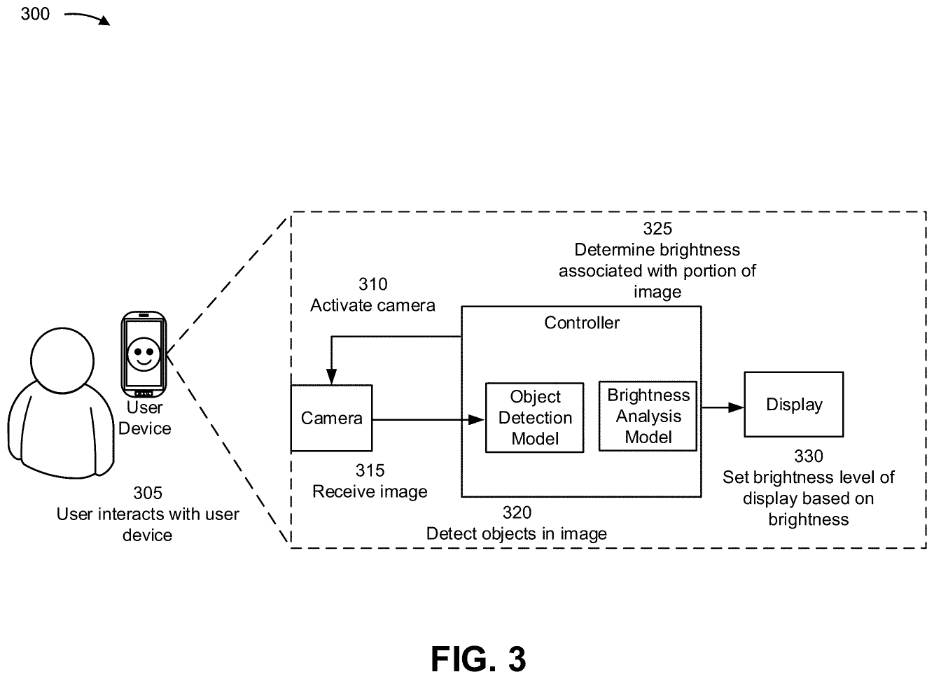

FIG. 3 is a diagram of an example aspect 300 associated with using an image captured by a camera of a user device to determine and/or set a brightness level of a display of the user device, in accordance with the present disclosure. As shown in FIG. 3, example aspect 300 includes a user device with a controller, a camera, and a display. The user device of example aspect 300 may correspond to the user device 110 of FIG. 1 and/or the device 200 of FIG. 2.

As shown in FIG. 3, and by reference number 305, a user interacts with the user device. The user may interact with the user device by moving the user device, holding the user device, and/or positioning the user device in order to use the user device and/or perform one or more operations associated with the user device.

The user may interact with the user device by activating a camera of the user device. The camera may be positioned in any suitable location on the user device that provides a field of view of a physical environment of the camera. For example, the camera may be a camera with a field of view of a display-side of the user device (“display-side camera”). Additionally, or alternatively, the camera may have a field of view of a back-side of the user device (“back-side camera”) or a field of view that is opposite the field of view of the display-side camera. The user may activate the camera of the user device by opening and/or interacting with a camera application of the user device to use the camera and/or capture an image. The camera application (and/or camera) may operate in a preview mode to enable a user to view the field of view of the camera on a display of the user device. Accordingly, in the preview mode, the camera may stream images of the field of view of the camera to the display of the user device to permit the user to preview a potential depiction of an image that may be captured by the camera. Additionally, or alternatively, the camera may operate in an image capture mode (e.g., to capture one more still images of the physical environment of the user device) and/or a video capture mode (e.g., to capture a video of the physical environment of the user device), among other example capture modes of the camera.

The user may interact with the user device in associated with an authentication process that is performed based on a biometric of the user. For example, the user device may be configured to perform a facial recognition (and/or facial detection) analysis on one or more images captured by a camera (a “display-side camera”) with a field of view of a display-side of the user device. The facial recognition analysis may be performed on the one or more images to activate (e.g., power on, wake-up, and/or the like) the display when the user is detected and/or unlock the display when the user is recognized as an authorized user (according to the facial recognition analysis) to permit the user to interact with the user device. Additionally, or alternatively, the user device may perform the facial recognition analysis in association with the user opening and/or utilizing an application that involves or requires an authentication of the user. Accordingly, the user may position the user device in order to put the user's face within the field of view of the display-side camera of the user device (e.g., a camera that is positioned on a display-side of the user device).

As further shown in FIG. 3, and by reference number 310, the user device activates the camera. The controller of the user device may activate the camera according to and/or based on the user interacting with the user device and/or a user input to the user device (e.g., a user input to activate the camera and/or open the camera application). Accordingly, the user device may activate the camera to capture an image of the user (e.g., for facial recognition analysis), to stream an image of the physical environment of the user device to the display (e.g., while in a preview mode), and/or to capture an image or video of the physical environment, among other examples. In some aspects, the user device may receive an indication that the camera is to be activated and/or has been activated (e.g., via the user input and/or an instruction associated with an application activating the camera).

As further shown in FIG. 3, and by reference number 315, the user device receives an image via the camera (e.g., an image of a physical environment of the user device). For example, the controller may receive the image from the camera based on the camera being activated. Accordingly, the user device may receive the image the image in association with the camera of the user device capturing the image to perform a facial recognition analysis of the user, to present a preview of a field of view of the camera on the display, and/or to store and/or present a depiction of the field of view of the camera (e.g., an image or video that depicts the physical environment of the camera).

As further shown in FIG. 3, and by reference number 320, the user device detects an object in the image. For example, the controller of the user device, using an object detection model may analyze the image to identify one or more objects depicted in the image. The object detection model may include and/or be associated with any suitable image processing model that is configured to detect and/or recognize one or more objects depicted in the image. For example, the object detection model may utilize an edge detection technique, an entropy analysis technique, a bounding box technique, and/or other types of image processing techniques.

In some aspects, the user device may be configured to detect a foreground of the image and/or a background of the image. For example, the controller may identify a foreground of the image based on detecting an object in the foreground and/or determining that the object is within the foreground based on an identified clarity (or resolution) of the object appearing to be relatively higher than other portions of the image (which may be determined using edge detection, edge analysis and/or any other suitable image processing technique). Additionally, or alternatively, the user device may detect a background of the image based on identifying clarities of portions of the image that are indicative of being in the background of the image (e.g., relatively lower clarity). In this way, the user device may determine a resolution associated with whether an identified object that is depicted in an image is in a foreground or in a background of the image.

In some aspects, the user device may detect multiple objects depicted within the image. As described elsewhere herein, the user device may detect multiple objects to compare brightnesses of the object as depicted in the image and/or to set a brightness level of the display according to a difference between a first brightness of a first object and a second brightness of a second object.

In example aspect 300, the image may include a depiction of a face of the user. Accordingly, the detected object may correspond to the face of the user. Additionally, or alternatively, the object may correspond to other anatomical features of the user, such as eye features, nose features, mouth features, and/or ear features, among other examples. In some aspects, the user device may detect eyes of the user and/or a configuration of features of the eyes of the user. For example, as described elsewhere herein, to determine whether a brightness level of the display should be adjusted, the user device may identify whether attributes of the eyes of the user indicate that the user appears to be squinting and/or whether pupils of the eyes of the user are contracted or dilated at a particular level. Such attributes may be indicative of whether a brightness is too bright (e.g., a user squinting from a relatively far distance and/or with relatively contracted pupils may indicate that the user's eyes are being stressed or that the user is experiencing discomfort from the display) or too dim (e.g., a user squinting from a relatively close distance with relatively dilated pupils may indicate that the user is struggling to view what is presented on the display because the display is too dim).

Accordingly, as described herein, the object detection model may identify and/or indicate objects (or features of objects) to permit the user device (e.g., via the brightness analysis model of the controller) to determine a brightness of portions of the image that depicts the objects.

As further shown in FIG. 3, and by reference number 325, the user device determines a brightness associated with a portion of the image. For example, the controller, via the brightness analysis model, may determine a brightness of the portion of the image that depicts a detected object.

In some aspects, the user device may determine the brightness of a portion of an image based on pixel values associated with a portion of the image that includes an object. The user device (e.g., via the brightness analysis model) may select which portion of the image is to be selected according to one or more features or characteristics of an object that is depicted in the portion. For example, the user device may select a certain portion based on whether the portion appears to be associated with a foreground (or depict an object in the foreground of the image) and/or based on whether the portion appears to be associated with a background (or depicts an object in the background of the image). Additionally, or alternatively, the user device may select a portion of the image based on a clarity of features of an object depicted in the portion of the image. In some aspects, the user device may select a portion of the image based on a type of an object that is depicted in the image and/or a priority scheme associated with selecting portions of the image for a brightness analysis. For example, a priority scheme may indicate that a portion of an image that depicts one type of object (e.g., an anatomical feature of a user or a particular anatomical feature of a user) should be selected over a portion of the image that depicts another type of object (e.g., an object that is not associated with or related to a user). Accordingly, based on the priority scheme and a comparison of corresponding features of an object, the object (and/or a corresponding portion of the image that depicts the object) may be selected for a brightness analysis.

As described above, the image may be captured according to a user interaction with the user device. Therefore, in some aspects, the image may be received and/or captured in accordance with an operation or application of the user device that does not involve specifically needing to determine ambient lighting in the physical environment and/or adjusting a setting (e.g., a brightness level, a contrast level, and/or a color filter setting, among other examples) of a display of the user device. Accordingly, the user device may determine an amount of ambient light in a physical environment of the user device (e.g., based on a brightness of a portion of the image) without utilizing, consuming, or dedicating computing resources to specifically capture the image in order to determine the amount of ambient light. Moreover, the image may be captured during or in association with a user interaction, which typically corresponds to time periods when a brightness (or other setting) of a display of the user device may need to be set or adjusted (e.g., to enable the user to easily see and/or interpret what is being presented on the display).

The brightness analysis model may include one or more machine learning models that are configured to predict a brightness of a portion of another image that may be captured by the user device (e.g., a subsequently received image of an image stream captured by the camera as described herein). For example, the brightness analysis model may include and/or utilize a recurrent neural network that is configured to weigh a brightness of one or more features of an object based on a depiction of the one or more features of the object within a stream of received images. The brightness analysis model may determine (or predict) a brightness of the object based on pixel values of the portion of the image that includes the object and a normalization of pixel values of corresponding pixels associated with the object as depicted in previously received images. The normalization of the pixel values may be based on a normalized histogram of pixel values that are associated with the previously received images. Accordingly, using the normalized histogram and pixel values of the object in the received image, the brightness analysis model may predict what a brightness of the object may be in a subsequently received image.

The recurrent neural network may include or be associated with a long short-term memory (LSTM) layer of the brightness analysis model. The features may correspond to a size of the object, a distance between the object and the camera (e.g., a distance determined using any suitable image processing technique and/or distance analysis technique), a characteristic of the object (e.g., a smoothness of a surface of the object, shininess of a surface of the object, a color of the object), a type of the object (e.g., whether a user related object or a non-user related object), and/or previously detected features of the object in previously received images. Accordingly, as described herein, as the recurrent neural network analyzes an object depicted in a stream of images from the camera, the brightness analysis model may predict a brightness of a portion of a subsequent image that would depict the object. In this way, based on the predicted brightness for the object.

In some aspects, the LSTM layer includes multiple recurrent networks that are associated with individual objects that are detected within images of an image stream. Accordingly, in some aspects, for each object that is identified in an image, a recurrent neural network may be configured to analyze the features of the object and weigh pixel values of the features of the object in order to predict a brightness of the object in a subsequently received image and/or correspondingly adjust or set a brightness of the display of the user device according to the predicted brightness of the object. In some aspects, the brightness analysis model may select an object for a brightness analysis over another object according to the predicted brightness of the object. For example, the brightness analysis model may select the object for use in setting the brightness level of the display based at least one part on respective sizes of the object and the other object as depicted in the image, and/or respective distances from the camera of the object and the other object as depicted in the image, respective surface characteristics of the object and the other object as depicted in the image, and/or respective types of the object and the other object.

As further shown in FIG. 3, and by reference number 330, the user device sets the brightness level of the display based on brightness of the portion of the image. For example, the user device may increase or decrease the brightness level according to a predicted brightness of the object (or an appearance of the object) in a subsequently received image, as determined or indicated by the brightness analysis model.

In some aspects, the user device may set the brightness level based on a comparison of brightnesses of different portions of the image. For example, for a first portion associated with an object (e.g., an object in the foreground of the image) and a second portion that does not include the object or is separate from the first portion, (e.g., a portion that is indicative of a level of ambient light in the physical environment of the user device, such as a portion of the object that is determined to be a background of the image), the user device may increase a brightness of the display based on determining that the second portion is brighter than the first portion. On the other hand, if the user device determines that the first portion is brighter than the second portion, the user device may decrease the brightness level of the display. The degree of adjustment to a current brightness level of the display may be based on a degree of distance between the first brightness of the first portion and the second brightness of the second portion. For example, if the degree of difference is relatively high, the degree of adjustment to the brightness level may be relatively higher, and if the degree of difference is relatively low, the degree of adjustment to the brightness level may be relatively low. In some aspects, the user device may adjust and/or set the brightness level (or other setting) of the display based on a change in brightness of the image relative to one or more received brightnesses. For example, if a brightness of the object appears to slowly be changing between images, the user device may increase a degree of adjustment (relative to a previous degree of adjustment) to more quickly set the brightness level the display to an optimal level according to the ambient lighting (or other conditions) of the physical environment.

In this way, as described herein, a user device may utilize an image from a camera to determine and set a brightness level of a display of the user device, thereby eliminating the need for a light sensor to measure ambient lighting in an environment and/or providing light measurements that are used to determine or set the brightness level of the display. Accordingly, the user device may be less complex relative to other user devices (e.g., because the user device does not need or utilize a light sensor), may conserve hardware resources associated with including or using a light sensor, and/or may conserve computing resources associated with including or using a light sensor.

As indicated above, FIG. 3 is provided as an example. Other examples may differ from what is described with regard to FIG. 3. The number and arrangement of devices shown in FIG. 3 are provided as an example. In practice, there may be additional devices, fewer devices, different devices, or differently arranged devices than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) shown in FIG. 3 may perform one or more functions described as being performed by another set of devices shown in FIG. 3.

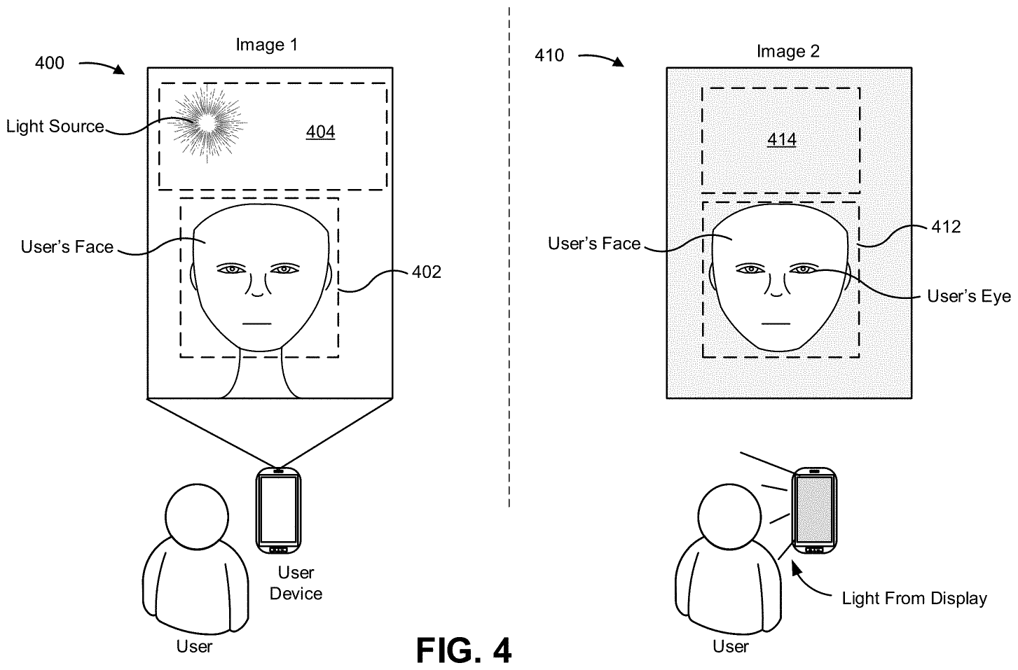

FIG. 4 is a diagram of one or more example aspects associated with an analysis of an image for determining and setting a brightness level of a display of a user device. As described herein, the user device (e.g., via a controller) may determine and/or set a brightness level of the display of the user device based on a brightness level of a first portion of the image and a brightness level of a second portion of the image.

As shown in FIG. 4, and in an example aspect 400, a camera of the user device may capture a first image (Image 1) in a physical environment with relatively bright ambient lighting (e.g., during a relatively bright day, when in a relatively well-lit room, or the like) caused by a light source. As shown, the first image may depict the user's face (e.g., because the user is interacting with the user device and/or viewing the display of the user device). The user device may analyze the first image to identify an object (e.g., the face of the user) in order to designate a first portion 402 of the first image for a brightness analysis, as described herein. For example, the user device may analyze the first image (e.g., using facial recognition or another image processing model) and identify the face of the user as depicted in the first image (e.g., based on the face of the user being in the foreground of the image).

The user device may designate the first portion 402 of the first image for a brightness analysis to determine the brightness level of the display according to one or more characteristics of the face of the user (e.g., because a face may be prioritized over other identified objects, such as the light source). The user device may designate a second portion 404 of the image for the brightness based on the second portion 404 of the first image being separate from the first portion 402 (and/or based on corresponding to a background of the first image). The user device may determine, via a brightness analysis (e.g., an analysis performed via the brightness analysis model), a first brightness of the first portion 402 of the first image and a second brightness of the second portion 404 of the first image. As described herein, the second brightness may be indicative of the relatively bright ambient lighting in the physical environment (e.g., due to being associated with a background of the image).

According to the brightness analysis of the first image, because the ambient lighting in the physical environment is relatively bright, the user device may determine that a first brightness of the first portion 402 of the first image may be similar to the second brightness of the second portion 404 of the first image (e.g., because the relatively bright ambient lighting may cause the face of the user to appear to have a same brightness as a background of the first image). In such a case, the user device may increase the brightness level of the display (e.g., to enhance the user's ability to view content on the display).

As shown in FIG. 4, and in an example aspect 410, the camera of the user device may capture a second image (Image 2) in a physical environment with relatively dim ambient lighting (e.g., during a relatively dark night, when in a relatively unlit room, due the physical environment not including a light source other than the display of the user device, or the like). As shown, the second image may depict the user's face being relatively brighter than the remainder of the second image. For example, because the user is interacting with the user device and/or viewing the display of the user device, the display (or a backlight of the display) may emit light toward the user's face, and the user's face may reflect the light from the display because the user's face is nearer the display of the user device relative to other objects in the physical environment (e.g., objects that would otherwise appear in a background of the second image).

Similar to example aspect 400, the user device may analyze the second image to identify an object (e.g., the face of the user) in order to designate, for a brightness analysis described herein, a first portion 412 of the second image and a second portion 414 of the second image. The user device may determine, (e.g., via the brightness analysis model), a first brightness of the first portion 412 of the second image and a second brightness of the second portion 414 of the second image. Because the ambient lighting in the physical environment is relatively dim, the user device may determine that a first brightness of the first portion 412 of the second image is relatively brighter than the second brightness of the second portion of the second image (e.g., because reflected light from the display may cause the face of the user to appear brighter than a background of the second image because less light may reach or be reflected from objects behind the user's face). In such a case, the user device may decrease the brightness level of the display (e.g., to avoid wasting resources consumed by the display having a relatively higher brightness and/or to enhance the user's ability to view content on the display).

In some aspects, the user device may analyze characteristics of the user's eye, as depicted in the second image to set the brightness of the display. For example, if the user device determines from an analysis of the user's eye that the user is squinting (e.g., due to strain on the user's eye caused by the backlight being too bright), the user device may decrease the brightness level of the display (or the backlight of the display) to reduce harm to the eyes of the user from the display having a relatively higher brightness.

As indicated above, FIG. 4 is provided as an example. Other examples may differ from what is described with regard to FIG. 4.

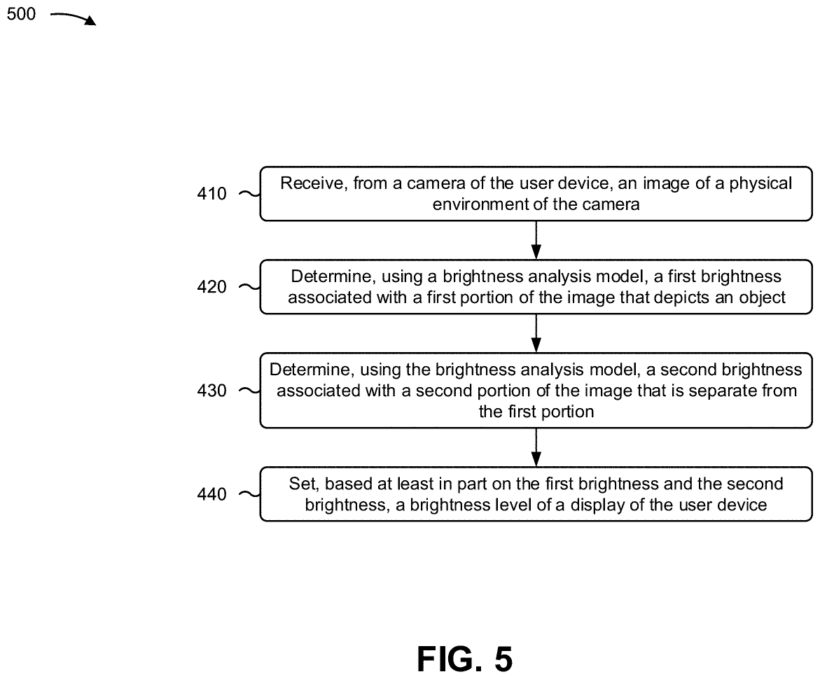

FIG. 5 is a flowchart of an example process 500 associated with using an image captured by a camera of a user device to determine and/or set a brightness level of a display of the user device, as described herein. In some aspects, one or more process blocks of FIG. 5 are performed by a user device (e.g., the user device 110). Additionally, or alternatively, one or more process blocks of FIG. 5 may be performed by one or more components of the device 200, such as the processor 210, the memory 215, the storage component 220, the input component 225, the output component 230, the communication interface 235, the sensor 240, and/or the camera 245.

As shown in FIG. 5, process 500 may include receiving, from a camera, an image of a physical environment of the camera (block 510). For example, the user device may receive, from a camera of the user device, an image of a physical environment of the camera, as described above. The camera may be a camera of the user device.

As further shown in FIG. 5, process 500 may include determining, using a brightness analysis model, a first brightness associated with a first portion of the image that depicts an object (block 520). For example, the user device may determine, using a brightness analysis model, a first brightness associated with a first portion of the image that depicts an object, as described above.

As further shown in FIG. 5, process 500 may include determining, using the brightness analysis model, a second brightness associated with a second portion of the image that is separate from the first portion (block 530). For example, the user device may determine, using the brightness analysis model, a second brightness associated with a second portion of the image that is separate from the first portion, as described above.

As further shown in FIG. 5, process 500 may include setting, based at least in part on the first brightness and the second brightness, a brightness level of a display of the user device (block 540). For example, the user device may set, based at least in part on the first brightness and the second brightness, a brightness level of a display of the user device, as described above.

Process 500 may include additional aspects, such as any single aspect or any combination of aspects described below and/or in connection with one or more other processes described elsewhere herein.

In a first aspect, process 500 includes detecting, prior to receiving the image, a user interaction associated with unlocking a lock screen of the user device, wherein the image is received from the camera based at least in part on detecting the user interaction.

In a second aspect, alone or in combination with the first aspect, process 500 includes receiving, prior to receiving the image, an indication that the camera has been activated according to at least one of a user input associated with capturing video and/or one or more images, or an application activating the camera.

In a third aspect, alone or in combination with one or more of the first and second aspects, the object is identified using an object detection model that is configured to indicate, to the brightness analysis model, features of identified objects in an image stream received from the camera, wherein the image is a frame of the image stream.

In a fourth aspect, alone or in combination with one or more of the first through third aspects, process 500 includes identifying, using an object detection model, the object and another object, and selecting, according to a priority scheme and based at least in part on a comparison of corresponding features of the object and the other object as depicted in the image, the object for the brightness analysis model to determine the first brightness.

In a fifth aspect, alone or in combination with one or more of the first through fourth aspects, the corresponding features comprise at least one of respective sizes of the object and the other object as depicted in the image, respective distances from the camera of the object and the other object as depicted in the image, respective surface characteristics of the object and the other object as depicted in the image, or respective types of the object and the other object.

In a sixth aspect, alone or in combination with one or more of the first through fifth aspects, determining the first brightness comprises identifying pixel values of pixels of the first portion, and determining the first brightness based at least in part on the pixel values and a normalization of pixel values of corresponding pixels associated with the object as depicted in previously received images.

In a seventh aspect, alone or in combination with one or more of the first through sixth aspects, the second brightness is indicative of a level of ambient lighting in the physical environment.

In an eighth aspect, alone or in combination with one or more of the first through seventh aspects, setting the brightness level of the display comprises determining that the first brightness is brighter than the second brightness, and reducing the brightness level of the display.

In a ninth aspect, alone or in combination with one or more of the first through eighth aspects, setting the brightness level of the display comprises determining that the second brightness is brighter than the first brightness, and increasing the brightness level of the display.

In a tenth aspect, alone or in combination with one or more of the first through ninth aspects, the brightness analysis model comprises at least one of a recurrent neural network, or a long short-term memory layer.

In an eleventh aspect, alone or in combination with one or more of the first through tenth aspects, the image is a frame of an image stream that is received in association with the camera being in a preview mode.

In a twelfth aspect, alone or in combination with one or more of the first through eleventh aspects, process 500 includes identifying that the object depicted in the image is an eye of a user of the user device, wherein the image is a first image, determining a first measurement of an attribute of the eye, receiving, from the camera, a second image that depicts the eye, determining a second measurement of the attribute of the eye as depicted in the second image, and adjusting, based at least in part on the second brightness, the brightness level based at least in part on a difference in the first measurement and the second measurement.

Although FIG. 5 shows example blocks of process 500, in some aspects, process 500 includes additional blocks, fewer blocks, different blocks, or differently arranged blocks than those depicted in FIG. 5. Additionally, or alternatively, two or more of the blocks of process 500 may be performed in parallel.

The following provides an overview of some Aspects of the present disclosure:

Aspect 1: A method performed by a user device, comprising: receiving, from a camera of the user device, an image of a physical environment of the camera; determining, using a brightness analysis model, a first brightness associated with a first portion of the image that depicts an object; determining, using the brightness analysis model, a second brightness associated with a second portion of the image that is separate from the first portion; and setting, based at least in part on the first brightness and the second brightness, a brightness level of a display of the user device.

Aspect 2: The method of Aspect 1, further comprising: detecting, prior to receiving the image, an unlock event associated with unlocking a lock screen of the user device, wherein the image is received from the camera based at least in part on detecting the unlock event.

Aspect 3: The method of Aspects 1 and/or 2, further comprising: receiving, prior to receiving the image, an indication that the camera has been activated according to at least one of: a user input associated with capturing video and/or one or more images, or an application activating the camera.

Aspect 4: The method of any of Aspects 1-3, wherein the object is identified using an object detection model that is configured to indicate, to the brightness analysis model, features of identified objects in an image stream received from the camera, wherein the image is a frame of the image stream.

Aspect 5: The method of any of Aspects 1-4, further comprising, prior to determining the first brightness: identifying, using an object detection model, the object and another object; and selecting, according to a priority scheme and based at least in part on a comparison of corresponding features of the object and the other object as depicted in the image, the object for the brightness analysis model.

Aspect 6: The method of Aspect 5, wherein the corresponding features comprise at least one of: respective sizes of the object and the other object as depicted in the image, respective distances from the camera of the object and the other object as depicted in the image, respective surface characteristics of the object and the other object as depicted in the image, or respective types of the object and the other object.

Aspect 7: The method of any of Aspects 1-6, wherein determining the first brightness comprises: identifying pixel values of pixels of the first portion; and determining the first brightness based at least in part on the pixel values and a normalization of pixel values of corresponding pixels associated with the object as depicted in previously received images.

Aspect 8: The method of any of Aspects 1-7, wherein the second brightness is indicative of a level of ambient lighting in the physical environment.

Aspect 9: The method of any of Aspects 1-8, wherein setting the brightness level of the display comprises: determining that the first brightness is brighter than the second brightness; and reducing the brightness level of the display.

Aspect 10: The method of any of Aspects 1-9, wherein setting the brightness level of the display comprises: determining that the second brightness is brighter than the first brightness; and increasing the brightness level of the display.

Aspect 11: The method of any of Aspects 1-10, wherein the brightness analysis model comprises at least one of: a recurrent neural network, or a long short-term memory layer.

Aspect 12: The method of any of Aspects 1-11, wherein the image is a frame of an image stream that is received in association with the camera being in a preview mode.

Aspect 13: The method of any of Aspects 1-12, further comprising: identifying that the object depicted in the image is an eye of a user of the user device, wherein the image is a first image; determining a first measurement of an attribute of the eye; receiving, from the camera, a second image that depicts the eye; determining a second measurement of the attribute of the eye as depicted in the second image; and adjusting, based at least in part on the second brightness, the brightness level based at least in part on a difference in the first measurement and the second measurement.

Aspect 14: An apparatus for wireless communication at a device, comprising a processor; memory coupled with the processor; and instructions stored in the memory and executable by the processor to cause the apparatus to perform the method of one or more of Aspects 1-13.

Aspect 15: A device for wireless communication, comprising a memory and one or more processors coupled to the memory, the one or more processors configured to perform the method of one or more of Aspects 1-13.

Aspect 16: An apparatus for wireless communication, comprising at least one means for performing the method of one or more of Aspects 1-13.

Aspect 17: A non-transitory computer-readable medium storing code for wireless communication, the code comprising instructions executable by a processor to perform the method of one or more of Aspects 1-13.

Aspect 18: A non-transitory computer-readable medium storing a set of instructions for wireless communication, the set of instructions comprising one or more instructions that, when executed by one or more processors of a device, cause the device to perform the method of one or more of Aspects 1-13.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method performed by a user device, comprising:
receiving, from a camera, an image of a physical environment of the camera;
determining, using a brightness analysis model, a first brightness associated with a first portion of the image that depicts an object;
determining, using the brightness analysis model, a second brightness associated with a second portion of the image that is separate from the first portion; and
setting, based at least in part on the first brightness and the second brightness, a brightness level of a display of the user device.

2. The method of claim 1, further comprising:
detecting, prior to receiving the image, a user interaction associated with unlocking a lock screen of the user device,
wherein the image is received from the camera based at least in part on detecting the user interaction.

3. The method of claim 1, further comprising:
receiving, prior to receiving the image, an indication that the camera has been activated according to at least one of:
a user input associated with capturing video and/or one or more images, or
an application activating the camera.

4. The method of claim 1, wherein the object is identified using an object detection model that is configured to indicate, to the brightness analysis model, features of identified objects in an image stream received from the camera,
wherein the image is a frame of the image stream.

5. The method of claim 1, further comprising, prior to determining the first brightness:
identifying, using an object detection model, the object and another object; and
selecting, according to a priority scheme and based at least in part on a comparison of corresponding features of the object and the other object as depicted in the image, the object for the brightness analysis model to determine the first brightness.

6. The method of claim 5, wherein the corresponding features comprise at least one of:
respective sizes of the object and the other object as depicted in the image,
respective distances from the camera of the object and the other object as depicted in the image,
respective surface characteristics of the object and the other object as depicted in the image, or
respective types of the object and the other object.

7. The method of claim 1, wherein determining the first brightness comprises:
identifying pixel values of pixels of the first portion; and
determining the first brightness based at least in part on the pixel values and a normalization of pixel values of corresponding pixels associated with the object as depicted in previously received images.

8. The method of claim 1, wherein the second brightness is indicative of a level of ambient lighting in the physical environment.

9. The method of claim 1, wherein setting the brightness level of the display comprises:
determining that the first brightness is brighter than the second brightness; and
reducing the brightness level of the display.

10. The method of claim 1, wherein setting the brightness level of the display comprises:
determining that the second brightness is brighter than the first brightness; and
increasing the brightness level of the display.

11. The method of claim 1, wherein the brightness analysis model comprises at least one of:
a recurrent neural network, or
a long short-term memory layer.

12. The method of claim 1, wherein the image is a frame of an image stream that is received in association with the camera being in a preview mode.

13. The method of claim 1, further comprising:
identifying that the object depicted in the image is an eye of a user of the user device,
wherein the image is a first image;
determining a first measurement of an attribute of the eye;
receiving, from the camera, a second image that depicts the eye;
determining a second measurement of the attribute of the eye as depicted in the second image; and
adjusting, based at least in part on the second brightness, the brightness level based at least in part on a difference in the first measurement and the second measurement.

14. A user device, comprising:
one or more memories; and
one or more processors, coupled to the one or more memories, configured to:
receive, from a camera, an image of a physical environment of the camera;
determine, using a brightness analysis model, a first brightness associated with a first portion of the image that depicts an object;
determine, using the brightness analysis model, a second brightness associated with a second portion of the image that is separate from the first portion; and
set, based at least in part on the first brightness and the second brightness, a brightness level of a display of the user device.

15. The user device of claim 14, wherein the one or more processors are further configured to:
detect, prior to receiving the image, an unlock event associated with unlocking a lock screen of the user device,
wherein the image is received from the camera based at least in part on detecting the unlock event.

16. The user device of claim 14, wherein the object is identified using an object detection model that is configured to indicate, to the brightness analysis model, features of identified objects in an image stream received from the camera,
wherein the image is a frame of the image stream.

17. The user device of claim 14, wherein the one or more processors are further configured to, prior to determining the first brightness:
identify, using an object detection model, the object and another object; and
select, according to a priority scheme and based at least in part on a comparison of corresponding features of the object and the other object as depicted in the image, the object for the brightness analysis model.

18. The user device of claim 14, wherein the one or more processors, to set the brightness level of the display, are configured to:
determine that the first brightness is brighter than the second brightness; and
reduce the brightness level of the display.

19. The user device of claim 14, wherein the one or more processors, to set the brightness level of the display, are configured to:
determine that the second brightness is brighter than the first brightness; and
increase the brightness level of the display.

20. A non-transitory computer-readable medium storing a set of instructions, the set of instructions comprising:
one or more instructions that, when executed by one or more processors of a user device, cause the user device to:
receive, from a camera, an image of a physical environment of the camera;
determine, using a brightness analysis model, a first brightness associated with a first portion of the image that depicts an object;
determine, using the brightness analysis model, a second brightness associated with a second portion of the image that is separate from the first portion; and
set, based at least in part on the first brightness and the second brightness, a brightness level of a display of the user device.

21. The non-transitory computer-readable medium of claim 20, wherein the one or more instructions further cause the user device to:
detect, prior to receiving the image, an unlock event associated with unlocking a lock screen of the user device,
wherein the image is received from the camera based at least in part on detecting the unlock event.

22. The non-transitory computer-readable medium of claim 20, wherein the object is identified using an object detection model that is configured to indicate, to the brightness analysis model, features of identified objects in an image stream received from the camera,
wherein the image is a frame of the image stream.

23. The non-transitory computer-readable medium of claim 20, wherein the one or more instructions further cause the user device to, prior to determining the first brightness:
identify, using an object detection model, the object and another object; and
select, according to a priority scheme and based at least in part on a comparison of corresponding features of the object and the other object as depicted in the image, the object for the brightness analysis model.

24. The non-transitory computer-readable medium of claim 20, wherein the one or more instructions, that cause the user device to set the brightness level of the display, cause the user device to:
determine that the first brightness is brighter than the second brightness; and
reduce the brightness level of the display.

25. The non-transitory computer-readable medium of claim 20, wherein the one or more instructions, that cause the user device to set the brightness level of the display, cause the user device to:
determine that the second brightness is brighter than the first brightness; and
increase the brightness level of the display.

26. An apparatus, comprising:
means for receiving, from a camera, an image of a physical environment of the camera;
means for determining, using a brightness analysis model, a first brightness associated with a first portion of the image that depicts an object;
means for determining, using the brightness analysis model, a second brightness associated with a second portion of the image that is separate from the first portion; and
means for setting, based at least in part on the first brightness and the second brightness, a brightness level of a display of the apparatus.

27. The apparatus of claim 26, further comprising:
means for detecting, prior to receiving the image, an unlock event associated with unlocking a lock screen of the apparatus,
wherein the image is received from the camera based at least in part on detecting the unlock event.

28. The apparatus of claim 26, further comprising:
means for identifying, prior to determining the first brightness and using an object detection model, the object and another object; and
means for selecting, according to a priority scheme and based at least in part on a comparison of corresponding features of the object and the other object as depicted in the image, the object for the brightness analysis model.

29. The apparatus of claim 26, wherein the means for setting the brightness level of the display comprises:
means for determining that the first brightness is brighter than the second brightness; and
means for reducing the brightness level of the display.

30. The apparatus of claim 26, wherein the means for setting the brightness level of the display comprises:
means for determining that the second brightness is brighter than the first brightness; and
means for increasing the brightness level of the display.
